(19) United States
(12) Patent Application Publication
(10) Pub. No.: US 2022/0279738 A1
(43) Pub. Date: Sep. 8, 2022

(54) GREENING MODULE, GREENING DEVICE, GREENING BODY AND METHOD FOR INSTALLING GREENING MODULE

(71) Applicant: Chun-hung HUANG, Xiamen (CN)

(72) Inventor: Chun-hung HUANG, Xiamen (CN)

(21) Appl. No.: 17/826,394

(22) Filed: May 27, 2022

Related U.S. Application Data
(63) Continuation of application No. PCT/CN2020/131344, filed on Nov. 25, 2020.

(30) Foreign Application Priority Data
Dec. 18, 2019 (CN) 201911311124.0

(51) Int. Cl. A01G 20/20; A01G 9/24; A01G 9/02; C08L 75/04

(52) U.S. Cl. CPC A01G 20/20; A01G 9/247; A01G 9/025; C08L 75/04; C08L 2203/14

(57) ABSTRACT

Embodiments provide a greening module, a greening device, a greening body and a method for installing the greening module. In the embodiments, the greening device includes at least one greening module including plants, a plant culture layer, an adhering part, and a waterproof layer, wherein: one side of the plant culture layer is configured for cultivating the plants, and at least part of a surface of an other side is provided with the adhering part; the waterproof layer is provided between the plant culture layer and the adhering part.

### RELATED APPLICATIONS

The present disclosure is a continuation of International Patent Application No. PCT/CN2020/131344, filed on Nov. 25, 2020, which claims priority to Chinese Patent Application No. 201911311124.0, filed on Dec. 18, 2019. International Patent Application No. PCT/CN2020/131344 and Chinese Patent Application No. 201911311124.0 are incorporated herein by reference.

### TECHNICAL FIELD

The present disclosure relates to the field of urban greening, and in particular, to a greening module, a greening device, a greening body and a method for installing the greening module.

### BACKGROUND

In today's world, with the accelerating process of industrialization, air pollution is becoming more and more serious, and smog frequently occurs. Also due to the development needs of industrialization, the planning amount of urban green space is extremely limited. In order to solve the increasingly serious air pollution problem, and improve people's lives quality, roof greening technology is emerged. However, most of the existing roof greening technologies use soil for cultivating, and steel strips or iron nets for fixing. Although the structure can increase the green area of the city on the roof, it not only needs to remove the plants first, then remove the soil and finally remove the fixing device, and once it is disassembled and assembled again, it needs to go through the steps of fixing, cultivating, and planting. The disassembly and assembly process is complicated and requires a lot of manpower and material resources. Therefore, there is an urgent need for a greening technology that is easy to disassemble and assemble.

### SUMMARY

In order to solve the problems mentioned in the above background technology, a greening device provided by the present disclosure comprises at least one greening module comprising plants, a plant culture layer, an adhering part, and a waterproof layer, wherein:

one side of the plant culture layer is configured for cultivating the plants, and at least part of a surface of an other side is provided with the adhering part;

the waterproof layer is provided between the plant culture layer and the adhering part.

In an embodiment, the plant culture layer is a moisturizing layer.

In an embodiment, the moisturizing layer is a textile fabric that stores moisture.

In an embodiment, the adhering part is adhered by a Velcro, and the Velcro is divided into two pieces; one piece of the Velcro is fixed to the waterproof layer, and an other piece is fixed to a surface to be greened, and then the two pieces of Velcro are glued together.

In an embodiment, the adhering part is made of polyurethane foam caulking agent; the polyurethane foam caulking agent is easy to disassemble when being torn in a specific direction, but is extremely difficult to disassemble outside the specific direction by external force.

In an embodiment, the greening device is composed of a plurality of greening modules.

In an embodiment, the greening device further comprises water retaining strips; wherein the water retaining strips are connected with a plurality of plant culture layers and waterproof layers at a side of the greening device.

In an embodiment, the water retaining strips are connected to a periphery of the greening device, and the water retaining strips are firmly connected with each other.

The present disclosure further provides a greening body, adopting at least one greening device, the greening device comprising at least one greening module comprising plants, a plant culture layer, an adhering part, and a waterproof layer, wherein:

one side of the plant culture layer is configured for cultivating the plants, and at least part of a surface of an other side is provided with the adhering part; the waterproof layer is provided between the plant culture layer and the adhering part; the adhering part is adhered to a body to be greened;

a placing surface is provided on a surface of the greening body; the placing surface is provided with a protective sticker, and the adhering part is adhered to the protective sticker, such that the greening device is adhered to the placing surface.

In an embodiment, the greening body is provided with a fixing belt.

The present disclosure further provides a method for installing a greening module, wherein the method comprises steps of:

S100, providing at least one greening device;

where, the greening device comprising at least one greening module comprising plants, a plant culture layer, an adhering part, and a waterproof layer, wherein:

one side of the plant culture layer is configured for cultivating the plants, and at least part of a surface of an other side is provided with the adhering part; the waterproof layer is provided between the plant culture layer and the adhering part; the adhering part is adhered to a body to be greened;

S110, culturing the plants on the plant culture layer in advance;

S120, adhering the adhering part on the plant culture layer where the plants are cultivated with the body to be greened.

In an embodiment, when the greening module is installed on a placing surface that is not perpendicular to the ground, the method comprises steps of:

S210, combining the plant culture layer with the waterproof layer;

S220, cultivating the plants on the plant culture layer to form the greening module;

S230, affixing the protective sticker on the body to be greened;

S240, adhering the greening module to the body to be greened;

S250, connecting the water retaining strip to an edge of the greening module;

when it needs to be replaced, the greening module is just torn off from the protective sticker.

In an embodiment, when the greening module is installed on a placing surface perpendicular to the ground, the method comprises steps of:

S310, combining the plant culture layer with the waterproof layer;

S320, cultivating the plants on the plant culture layer to form the greening module;

S330, affixing the protective sticker on the body to be greened;

S340, adhering the greening module to the body to be greened.

when it needs to be replaced, the greening module is just torn off from the protective sticker.

In an embodiment, when the greening module is installed in a typhoon-prone area, the method comprises steps of:

S410, combining the plant culture layer with the waterproof layer;

S420, cultivating the plants on the plant culture layer to form the greening module;

S430, affixing the protective sticker on the body to be greened;

S440, adhering the greening module to the body to be greened;

S450, connecting the water retaining strip to an edge of the greening module;

S460, wrapping the greening module and the water retaining strip with a fixing belt.

when it needs to be replaced, the greening module is just torn off from the protective sticker.

The present disclosure provides a greening module, a greening device, a greening body and a greening method. A greening module, through the structure of plants, a plant culture layer, and an adhering part, can solve the problems that the existing greening module is difficult for disassembling and assembling, is only suitable for flat horizontal surfaces, with an excessive weight, is easy to raise dust, makes the plants grow too long and the like. It can be quickly disassembled and assembled, convenient for replacing, suitable for various types of surfaces to be greened, can greatly reduce weight, without dust, and make moderate growth of plants.

The present disclosure further includes a greening device, which solves the problems that the existing greening technology can only be applied to a relatively regular plane, and the plants need to be replanted once damaged, such that the greening device can be configured on both regular and irregular bodies to be greened, and the plant can be replaced directly after the plant is damaged. The present disclosure also includes a greening body, through the structure of the greening body, the placing surface and the adhering part, the problems that the existing greening technology can only be configured on a plane with a large bearing capacity is solved, such that as long as the body to be greened has a certain quality, it can be applied regardless of whether the placing surface is flat, inclined or vertical. The structure is simple and practical.

The present disclosure also provides a method for installing a greening module, including culturing the plants on the plant culture layer in advance; adhering the adhering part on the plant culture layer where the plants are cultivated with a body to be greened. The installation can be completed quickly without damaging the plants. The installed greening module not only has a stable position, but also has good water retention.

### BRIEF DESCRIPTION OF DRAWINGS

In order to more clearly illustrate the embodiments of the present disclosure or the technical solutions in the prior art, the following briefly introduces the accompanying drawings that need to be used in the description of the embodiments or the prior art. Obviously, the accompanying drawings in the following description are some embodiments of the present disclosure. For those of ordinary skill in the art, other drawings can also be obtained according to these drawings without inventive efforts.

FIG. 1 is an assembly drawing of the greening body provided by the present disclosure;

FIG. 2 is a front view of the greening module provided by the present disclosure without a water retaining strip when the greening module is vertically arranged;

FIG. 3 is a perspective view of the greening module provided by the present disclosure without water retaining strips;

FIG. 4 is a top view of the greening device provided by the present disclosure;

FIG. 5 is a top view of the greening body provided by the present disclosure with the fixing belt;

FIG. 6 is an assembly diagram of the greening body, the water retaining strip and the fixing belt of the greening body provided by the present disclosure.

In the figures: 10, plants; 20, plant culture layer; 30, adhering layer; 40, waterproof layer; 50, protective sticker; 60, water retaining strip; 70, greening body; 71, placing surface; 80, fixing belt.

### DESCRIPTION OF EMBODIMENTS

In order to make the objects, technical solutions and advantages of the embodiments of the present disclosure clearer, the technical solutions in the embodiments of the present disclosure will be clearly and completely described below with reference to the accompanying drawings in the embodiments of the present disclosure. Obviously, the described embodiments are some embodiments of the present disclosure, but not all embodiments. Based on the embodiments of the present disclosure, all other embodiments obtained by those of ordinary skill in the art without inventive efforts shall fall within the protection scope of the present disclosure.

In the description of the present disclosure, it should be noted that the terms “center”, “longitudinal”, “lateral”, “up”, “down”, “front”, “rear”, “left”, “right”, “vertical”, “horizontal”, “top”, “left”, “bottom”, “inner”, “outer” and other orientation or positional relationship indicated are based on the orientation or positional relationship shown in the drawings, and is only for the convenience of describing the present disclosure and simplifying the description, rather than indicating or implying that the device or element referred to must have a particular orientation, be constructed and operate in a particular orientation, and therefore should not be construed as limiting the present disclosure. “connecting” or “connected” and similar words are not limited to physical or mechanical connections, but may include electrical connections, optical connections, and the like, whether direct or indirect.

The present disclosure provides a greening module, comprising plants 10, a plant culture layer 20 and an adhering part 30. Among them, one side of the plant culture layer 20 may be configured for cultivating plants, and at least part of the surface of the other side may be provided with the adhering part 30. The adhering part 30 may be configured for connecting with the body to be greened.

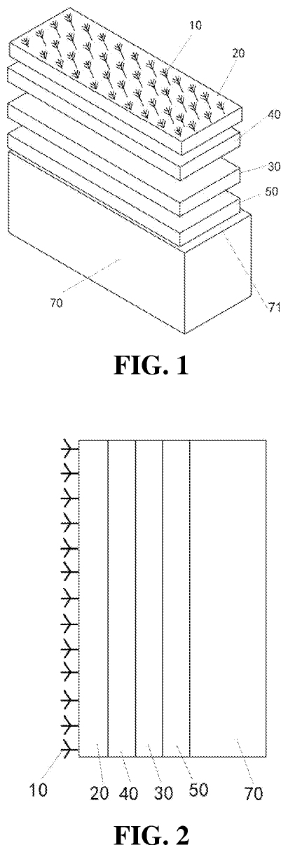

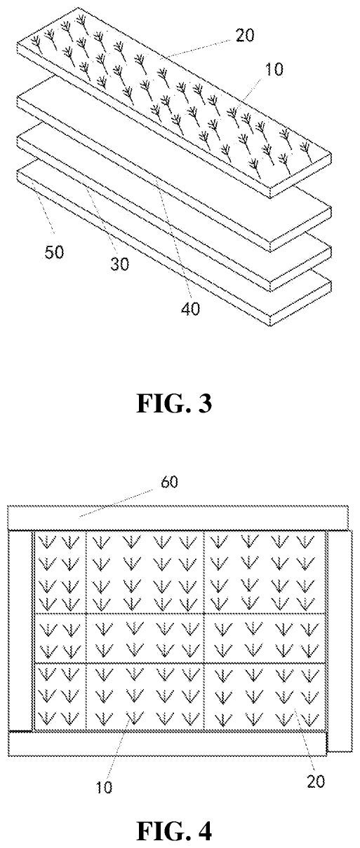

In the specific implementation, as shown in FIGS. 1-3, it may include the plants 10, a plant culture layer 20, and an adhering part 30. Wherein: one side of the plant culture layer 20 is configured for culturing the plants 10, and at least part of the surface of the other side is provided with the adhering part 30. The plant culture layer may be a soil-free structure, which not only greatly reduces the weight of the greening module, but also does not raise dust and does not pollute the air. At the same time, according to the growth of plants, in the case that the roots of plants cannot effectively stabilize rhizomes, the growth of the rhizome of the plants 10 will be restricted, such that the plants will not grow too high. The adhering part 30 may be configured for connecting with the body to be greened; the greening module may be fixed on the body to be greened by the adhering part 30, which is convenient and quick to disassemble and assemble. At the same time, the plant culture layer 20 and the adhering part 30 are relatively soft. The structure can be well-fitted with the body to be greened, and there is no requirement for the surface flatness of the body to be greened, it can be greened as long as it can be adhered.

In specific use, the plants 10 are cultivated on the plant culture layer 20 in advance, such that the plants 10 are rooted in the plant culture layer 20, and after the plants have grown, the adhering parts 30 are configured for adhering them to the body to be greened.

The greening module provided by the present disclosure can solve the problems that the existing greening module is difficult for disassembling and assembling, is only suitable for flat horizontal surfaces, with an excessive weight, is easy to raise dust, makes the plants grow too long and the like. It can be quickly disassembled and assembled, convenient for replacing, suitable for various types of surfaces to be greened, can greatly reduce weight, without dust, and make moderate growth of plants.

Preferably, the plant culture layer 20 may be a moisturizing layer.

During specific implementation, as shown in FIGS. 1-3, the plant culture layer 20 may be a moisturizing layer, and the moisturizing layer can be a moisturizing blanket or other textiles that can store a large amount of water. A large amount of water may be stored in the moisturizing layer, and the water contains nutrients and inorganic salts necessary for plants 10 growth. The rhizomes of the plants 10 can be fixed in the moisturizing layer, so the plants 10 can grow and survive normally, and the weight may be far less than the weight of the soil planting, which causes less pressure on the surface to be greened.

Preferably, the adhering method adopted by the adhering part 30 may include: adhering with a foaming agent, adhering with Velcro.

During the specific implementation, most of the existing greening modules for non-ground use are fixed by steel strips or iron nets, which not only causes great pressure on the surface to be greened, but also is extremely inconvenient to disassemble and assemble, requiring a large amount of manpower, material resources, without a good economic effect. The present embodiment is shown in FIGS. 1-3, the adhering part 30 may adopt at least one of the following adhering method: adhering with a foaming agent, adhering with Velcro and other adhering method. Wherein the foaming agent may adopt polyurethane foam caulking agent, this kind of foaming agent may be quick-drying and has high adhering stability. It is very easy to disassemble when it is pulled from a certain direction, but it is extremely difficult to disassemble when it is applied outside a certain direction. When using Velcro for adhering, the Velcro may be divided into two pieces. First, one piece of the Velcro is fixed with the plant culture layer 20 or the waterproof layer 40, and the other piece is fixed on the surface to be greened, and then the two pieces of Velcro are glued together. The two adhering method are not only light in weight and fast in adhering, but also easy to disassemble and assemble, and the greening module has good reusability.

Preferably, a waterproof layer 40 may be provided between the plant culture layer 20 and the adhering part 30.

During a specific implementation, as shown in FIGS. 1-3, a waterproof layer 40 may be provided between the plant culture layer 20 and the adhering part 30. The waterproof layer 40 can reduce the water loss of the plant culture layer 20 and prevent the direct connection between the plant culture layer 20 and the adhering part 30, and further eliminate the possibility of damaging the plant culture layer 20 when the plant culture layer 20 is directly pulled during disassembly.

Preferably, the plant 10 may be a perennial herb.

In a specific implementation, as shown in FIGS. 1-3, the plant 10 may be a perennial herb. The plant of the perennial herb does not grow too high and does not need to be planted every year, and is suitable for the greening plant in the present embodiment. Different varieties of perennial herbs each have different advantages, and different perennial herbs can be selected as the plants 10 of the greening module according to the different environments in which they are used.

The present disclosure further provides a greening device, which adopts the greening module according to any one of the above, and the greening device may be formed by splicing and combining a plurality of greening modules.

During a specific implementation, as shown in FIG. 4, the greening device may be formed by splicing and combining a plurality of greening modules. Under this structure, regardless of whether the shape of the body to be greened for the greening device is regular or irregular, the greening device formed by splicing and combining greening modules can be applied. At the same time, if one of the modules is damaged, only the damaged module is replaced in this structure, thereby improving the utilization rate of the product.

The greening device provided by the present disclosure solves the problems that the existing greening technology can only be applied to a relatively regular plane, and the plants need to be replanted once they are damaged. The greening device can be used on both regular and irregular bodies to be greened, the module can be replaced directly after the plant is damaged. The structure is simple and practical.

Preferably, a water retaining strip 60 may be further included. The water retaining strip 60 may be connected to a plurality of plant culture layers 20 and waterproof layers 40 on the side of the greening device.

During a specific implementation, as shown in FIGS. 4 and 6, a water retaining strip 60 may be also included. The water retaining strip 60 may be a foam product, or a steel product or a plastic product. The water retaining strips 60 may be connected with the plurality of plant culture layers 20 and waterproof layers 40 on the side of the greening device, such that he water retention performance of the greening device can be increased.

The present disclosure also provides a greening body, using the greening device as described in any one of the above. The greening body 70 may be provided with a placing surface 71 on the surface; the placing surface 71 may be adhered to the adhering part 30.

During a specific implementation, as shown in FIG. 1, the surface of the greening body 70 may be provided with a placing surface 71, and the placing surface 71 may be adhered to the adhering part 30. Since the greening device is light in weight and fast in adhering, the placing surface 71 can be a car roof or a car hood, a house roof or a side and top surface of a wall, or a side fence and a tin roof for engineering.

The greening body provided by the present disclosure has the structure of the greening body, the placing surface and the adhering part. The problems that the existing greening technology can only be used on a plane with a large bearing capacity is solved. As long as the body to be greened has a certain quality, it can be applied regardless of whether the placing surface is a flat surface, an inclined surface or a vertical surface. The structure is simple and practical.

Preferably, the placing surface 71 may be provided with a protective sticker 50; the adhering part 30 may be adhered to the protective sticker 50.

During a specific implementation, as shown in FIGS. 1-3, the placing surface 71 may be provided with a protective sticker 50. The protective sticker 50 has adhesive force, and the adhesive force of the protective sticker 50 may be configured for sticking it on the placing surface 71. The adhering part 30 may be adhered to the protective sticker 50. Under this structure, the adhering part 30 does not directly contact the placing surface 71, so the residual glue residue when replacing the module will not be left on the placing surface 71, and the seamless replacement on the placing surface 71 may be truly realized. When used in temporary greening, the protective sticker 50 can be torn off to restore the original state, leaving no glue residue on the placing surface 71.

Preferably, the greening body 70 may be provided with a fixing belt 80.

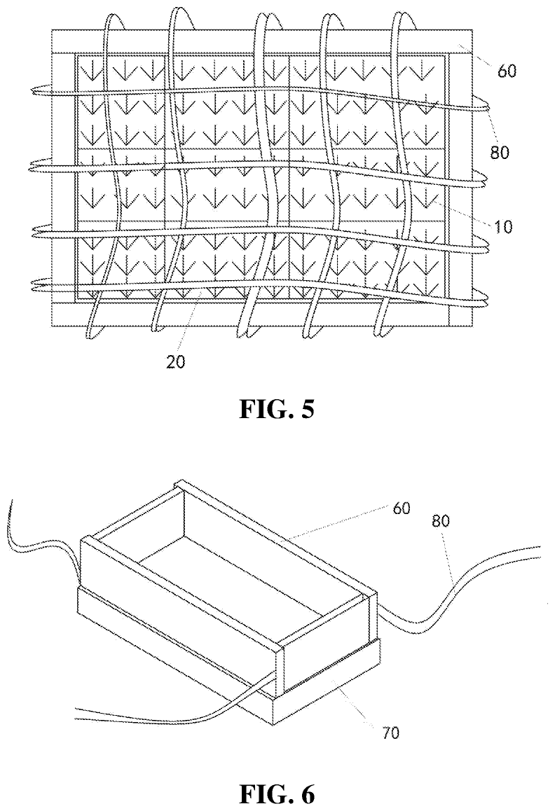

In a specific implementation, it is very difficult to install traditional green bodies in typhoon-prone areas. In the present embodiment, as shown in FIGS. 5-6, the greening body 70 may be provided with a fixing belt 80. The fixing belt 80 can wrap the greening device, the greening body 70 and the water retaining strip 60 together, so as to strengthen its resistance to typhoons. The water retaining strip 60 used, in this condition, may be made of rigid material or plastic.

The present disclosure also provides an method for installing the greening module, the method steps are as follows:

S110, culturing plants on the plant culture layer in advance;

S120, adhering the adhering part on the plant culture layer on which the plant is cultivated with the body to be greened.

During a specific implementation, when the greening module is installed on a placing surface that is not perpendicular to the ground, the method steps are as follows:

S210, combining the plant culture layer with the waterproof layer;

S220, cultivating plants on the plant culture layer to form a greening module;

S230, affixing the protective sticker on the body to be greened;

S240, adhering the greening module to the body to be greened;

S250, connecting the foam waterproof strip to the edge of the greening module.

When it needs to be replaced, the greening module can be just torn off from the protective sticker.

When the greening module is installed on a placing surface perpendicular to the ground, the method steps are as follows:

S310, combining the plant culture layer with the waterproof layer;

S320, cultivating the plants on the plant culture layer to form a greening module;

S330, affixing a protective sticker on the body to be greened;

S340, adhering the greening module to the body to be greened.

When it needs to be replaced, the greening module can be just torn off from the protective sticker.

When the greening module is installed in a typhoon-prone area, the method steps are as follows:

S410, combining the plant culture layer with the waterproof layer;

S420, cultivating the plants on the plant culture layer to form a greening module;

S430, affixing the protective sticker on the body to be greened;

S440, adhering the greening module to the body to be greened;

S450, connecting the steel or plastic waterproof strip to the edge of the greening module;

S460, wrapping the greening module and the waterproof strip with a fixing belt.

When it needs to be replaced, the greening module can be just torn off from the protective sticker.

Installing the greening module according to this method can quickly complete the installation process without damaging the plants; the installed greening module not only has a stable position, but also has good water retention.

Although the terms such as plant, plant culture layer, adhering part, waterproof layer, mesh cloth, sponge, water retaining strip, greening body, placing surface, etc. are often used herein, the possibility of using other terms is not excluded. These terms are used only to more conveniently describe and explain the essence of the present disclosure. It is contrary to the spirit of the present disclosure to interpret them as any kind of additional limitation.

Finally, it should be noted that the above embodiments are only used to illustrate the technical solutions of the present disclosure, but not to limit them. Although the present disclosure has been described in detail with reference to the foregoing embodiments, those of ordinary skill in the art should understand that: the technical solutions described in the foregoing embodiments can still be modified, or some or all of the technical features thereof can be equivalently replaced; and these modifications or replacements do not make the essence of the corresponding technical solutions deviate from the technical solution scope of the embodiments of the present disclosure.

What is claimed is:

1. A greening device, comprising at least one greening module comprising plants, a plant culture layer, an adhering part, and a waterproof layer, wherein:
one side of the plant culture layer is configured for cultivating the plants,
at least part of a surface of a second side of the plant culture layer is provided with the adhering part, and
the waterproof layer is provided between the plant culture layer and the adhering part.

2. The greening device according to claim 1, wherein the plant culture layer is a moisturizing layer.

3. The greening device according to claim 2, wherein the moisturizing layer is a textile fabric that stores moisture.

4. The greening device according to claim 1, wherein:
the adhering part is adhered by a hook and loop fastener,
the hook and loop fastener is divided into two pieces,
one of the two pieces of the hook and loop fastener is fixed to the waterproof layer,
a second of the two pieces of the hook and loop fastener is fixed to a surface to be greened, and
the two pieces of the hook and loop fastener are glued together.

5. The greening device according to claim 1, wherein:
the adhering part is made of polyurethane foam caulking agent,
the polyurethane foam caulking agent is configured to be disassemble when being torn in a specific direction.

6. The greening device according to claim 1, wherein the greening device is composed of a plurality of the greening modules.

7. The greening device according to claim 6, further comprising water retaining strips, wherein the water retaining strips are connected with a plurality of the plant culture layers and the waterproof layers at a side of the greening device.

8. The greening device according to claim 7, wherein:
the water retaining strips are connected to a periphery of the greening device, and
the water retaining strips are connected with each other.

9. A greening body, comprising at least one greening device, the greening device comprising at least one greening module comprising plants, a plant culture layer, an adhering part, and a waterproof layer, wherein:
one side of the plant culture layer is configured for cultivating the plants,
at least part of a surface of a second side of the plant culture layer is provided with the adhering part,
the waterproof layer is provided between the plant culture layer and the adhering part, the adhering part is adhered to a body to be greened,
a placing surface is provided on a surface of the greening body,
the placing surface is provided with a protective sticker, and
the adhering part is adhered to the protective sticker, such that the greening device is adhered to the placing surface.

10. The greening body according to claim 9, wherein the greening body is provided with a fixing belt.

11. A method for installing a greening module, comprising steps of:
S100, providing at least one greening device, wherein:
the greening device comprises at least one greening module comprising plants, a plant culture layer, an adhering part, and a waterproof layer,
one side of the plant culture layer is configured for cultivating the plants,
at least part of a surface of a second side of the plant culture layer is provided with the adhering part,
the waterproof layer is provided between the plant culture layer and the adhering part, and
the adhering part is adhered to a body to be greened;
S110, pre-growing the plants on the plant culture layer; and
S120, adhering the adhering part on the plant culture layer where the plants are cultivated with the body to be greened.

12. The method for installing according to claim 11, wherein when the greening module is installed on a placing surface that is not perpendicular to ground, the method comprises steps of:
S210, combining the plant culture layer with the waterproof layer;
S220, cultivating the plants on the plant culture layer to form the greening module;
S230, affixing a protective sticker on the body to be greened;
S240, adhering the greening module to the body to be greened; and
S250, connecting a water retaining strip to an edge of the greening module, wherein when the greening module is to be replaced, the greening module is torn off from the protective sticker.

13. The method for installing according to claim 11, wherein when the greening module is installed on a placing surface perpendicular to ground, the method comprises steps of:
S310, combining the plant culture layer with the waterproof layer;
S320, cultivating the plants on the plant culture layer to form the greening module;
S330, affixing a protective sticker on the body to be greened; and
S340, adhering the greening module to the body to be greened, wherein when the greening module is to be replaced, the greening module is torn off from the protective sticker.

14. The method for installing according to claim 11, wherein when the greening module is installed in a typhoon-prone area, the method comprises steps of:
S410, combining the plant culture layer with the waterproof layer;
S420, cultivating the plants on the plant culture layer to form the greening module;
S430, affixing a protective sticker on the body to be greened;
S440, adhering the greening module to the body to be greened;
S450, connecting a water retaining strip to an edge of the greening module; and
S460, wrapping the greening module and the water retaining strip with a fixing belt, wherein when the greening module is to be replaced, the greening module is torn off from the protective sticker.
